(19) United States
(12) Patent Application Publication
(10) Pub. No.: US 2021/0083890 A1
(43) Pub. Date: Mar. 18, 2021

(54) INFORMATION PROCESSING SYSTEM, INFORMATION PROCESSING METHOD, AND STORAGE MEDIUM FOR STORING INFORMATION PROCESSING PROGRAM

(71) Applicant: SHARP KABUSHIKI KAISHA, Sakai City (JP)

(72) Inventors: AKIHIRO KUMATA, Sakai City (JP); KEIKO HIRUKAWA, Sakai City (JP); SATOSHI TERADA, Sakai City (JP); DAISUKE YAMASHITA, Sakai City (JP)

(21) Appl. No.: 17/018,510

(22) Filed: Sep. 11, 2020

(30) Foreign Application Priority Data
Sep. 18, 2019 (JP) 2019-169407

(51) Int. Cl. H04L 12/18; G06Q 10/10; G06F 3/16

(52) U.S. Cl. CPC H04L 12/1822; G06F 3/167; G06Q 10/1095

(57) ABSTRACT

An information processing system according to the present disclosure includes a registration processor that registers, in a storage, location information indicating a location where a meeting is held, identification information of a voice processing device installed at the location, and identification information of a terminal device of a participant participating in the meeting, in a mutually associated manner, a voice acquirer that acquires voice information via the voice processing device in the meeting, a command specifier that specifies a command for executing a predetermined process, based on the voice information; an authority receiver that receives a grant request for an authority to execute the command, and an authority granter that grants the authority to a predetermined terminal device, based on the location information and the identification information of the terminal device, if the grant request is received by the authority receiver.

### INCORPORATION BY REFERENCE

This application is based upon and claims the benefit of priority from the corresponding Japanese Patent Application No. 2019-169407 filed on Sep. 18, 2019, the entire contents of which are incorporated herein by reference.

### BACKGROUND OF THE INVENTION

### Field of the Invention

The present disclosure relates to an information processing system, an information processing method, and a storage medium for storing an information processing program.

### Description of the Background Art

Conventionally, there has been proposed a system that enables holding a meeting using a plurality of devices connected to a network. For example, if a participant of the meeting selects an input target device and an output target device, the selected input target device generates image data according to the input target device, and the selected output target device executes an output processing according to the image data.

Here, for example, if a participant of the meeting brings his/her own terminal device (for example, a laptop computer) into the meeting room, and a command is executed in the terminal device by the voice of the participant, a process for registering the terminal device in a system and granting an execution authority for the command to the terminal device is required. Therefore, if there are a plurality of terminal devices and the execution authority is switched between the plurality of terminal devices during a meeting, it is necessary to perform the registration and cancellation process for the terminal device each time, which hinders the progress of the meeting.

### SUMMARY

An object of the present disclosure is to provide an information processing system, an information processing method, and a storage medium for storing an information processing program capable of efficiently switching a target device in which a command is executed by a voice during a meeting.

An information processing system according to an aspect of the present disclosure includes a registration processor that registers, in a storage, location information indicating a location where a meeting is held, identification information of a voice processing device installed at the location where the meeting is held, and identification information of a terminal device of a participant participating in the meeting, in a mutually associated manner, a voice acquirer that acquires voice information via the voice processing device in the meeting, a command specifier that specifies a command for executing a predetermined process, based on the voice information acquired from the voice acquirer, an authority receiver that receives a grant request for an authority to execute the command specified by the command specifier, and an authority granter that grants the authority to a predetermined terminal device, based on the location information and the identification information of the terminal device stored in the storage, if the grant request is received by the authority receiver.

An information processing method according to another aspect of the present disclosure includes using one or more processing devices to execute: registering, in a storage, location information indicating a location where a meeting is held, identification information of a voice processing device installed at the location where the meeting is held, and identification information of a terminal device of a participant participating in the meeting, in a mutually associated manner; acquiring voice information via the voice processing device in the meeting; specifying a command for executing a predetermined process, based on the voice information acquired; receiving a grant request for an authority to execute the command specified; and granting the authority to a predetermined terminal device, based on the location information and the identification information of the terminal device stored in the storage, if the grant request is received.

A non-transitory storage medium according to another aspect of the present disclosure is a non-transitory storage medium for storing an information processing program for causing one or more processing devices to execute: registering, in a storage, location information indicating a location where a meeting is held, identification information of a voice processing device installed at the location where the meeting is held, and identification information of a terminal device of a participant participating in the meeting, in a mutually associated manner; acquiring voice information via the voice processing device in the meeting, specifying a command for executing a predetermined process, based on the voice information acquired; receiving a grant request for an authority to execute the command specified; and granting the authority to a predetermined terminal device, based on the location information and the identification information of the terminal device stored in the storage, if the grant request is received.

According to the present disclosure, an information processing system, an information processing method, and a storage medium for storing an information processing program capable of efficiently switching a target device in which a command is executed by a voice during a meeting are provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a simplified configuration of a meeting system according to an embodiment of the present disclosure;

FIG. 2 is a functional block diagram illustrating a configuration of the meeting system according to the embodiment of the present disclosure;

FIG. 3 is a diagram illustrating an example of meeting room information utilized in the meeting system according to the embodiment of the present disclosure;

FIG. 4 is a diagram illustrating an example of device information utilized in the meeting system according to the embodiment of the present disclosure;

FIG. 5 is a diagram illustrating an example of user information utilized in the meeting system according to the embodiment of the present disclosure;

FIG. 6 is a diagram illustrating an example of meeting information utilized in the meeting system according to the embodiment of the present disclosure;

FIG. 7 is a diagram illustrating an example of participating terminal information utilized in the meeting system according to the embodiment of the present disclosure;

FIG. 8 is a diagram illustrating an example of participant information utilized in the meeting system according to the embodiment of the present disclosure;

FIG. 9 is a diagram illustrating an example of command information registered in the meeting system according to the embodiment of the present disclosure;

FIG. 10 is a diagram illustrating an example of command information registered in the meeting system according to the embodiment of the present disclosure;

FIG. 11 is a diagram illustrating an example of an operation screen displayed on a user terminal of the meeting system according to the embodiment of the present disclosure;

FIG. 12 is a diagram illustrating an example of an operation screen displayed on the user terminal of the meeting system according to the embodiment of the present disclosure;

FIG. 13 is a flowchart for explaining an example of a procedure of a request process included in a command control process executed in the meeting system according to the embodiment of the present disclosure;

FIG. 14 is a flowchart for explaining an example of a procedure of a registration processing included in a command control process executed in the meeting system according to the embodiment of the present disclosure;

FIG. 15 is a flowchart for explaining an example of a procedure of a grant process included in a command control process executed in the meeting system according to the embodiment of the present disclosure; and

FIG. 16 is a flowchart for explaining an example of a procedure of a command process included in a command control process executed in the meeting system according to the embodiment of the present disclosure.

### DETAILED DESCRIPTION

An embodiment of the present disclosure will be described below with reference to the attached drawings. The following embodiment is an example in which the present disclosure is embodied, and does not intend to limit the technical scope of the present disclosure.

The information processing system according to the present disclosure can be applied to, for example, a meeting in which a plurality of users participate in one location (a meeting room). The meeting system according to the present embodiment is an example of the information processing system according to the present disclosure. For example, in the meeting system according to the present embodiment, a voice processing device is arranged in a meeting room, and a cloud server that analyzes a voice of a user received from the voice processing device and specifies a command is provided. Further, the meeting system includes a display device being a command target device that executes the command, and a user terminal owned by each user participating in the meeting. The command target device includes the voice processing device. The command target device is an example of the terminal device according to the present disclosure.

### Meeting System 100

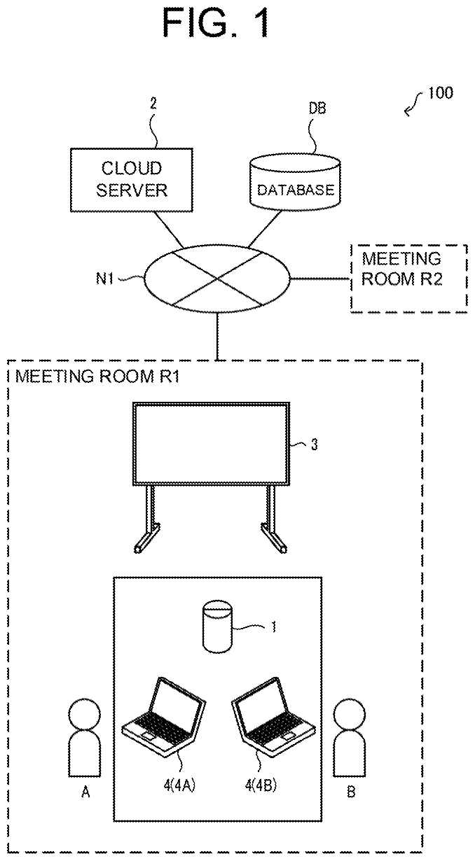

FIG. 1 is a diagram illustrating a simplified configuration of a meeting system according to an embodiment of the present disclosure. The meeting system 100 includes a voice processing device 1, a cloud server 2, a display device 3, a database DB, and a user terminal 4. The voice processing devices 1 is a microphone speaker device including a microphone and a speaker, such as an AI speaker or a smart speaker. Here, the voice processing device 1 installed in the meeting room R1 is illustrated. One or more voice processing devices 1 are installed in each meeting room. The display device 3 includes a display that displays various types of information. Here, the display device 3 installed in the meeting room R1 is illustrated. One or more display devices 3 are installed in each meeting room. The cloud server 2 is composed of, for example, one or more data servers (virtual servers). The database DB stores various types of data. The database DB may be included in any one of the voice processing device 1, the cloud server 2, the display device 3, and the user terminal 4, or may be dispersedly included in a plurality of devices. The user terminal 4 is a personal terminal device that a participant participating in the meeting carries to the meeting room. The voice processing device 1, the cloud server 2, the display device 3, the user terminal 4, and the database DB are connected to each other via the network N1. The network N1 is a communication network such as the Internet, LAN, WAN, or public telephone line. The voice processing device 1 is an example of the voice processing device according to the present disclosure. The display device 3 is an example of the display device and the terminal device according to the present disclosure. The user terminal 4 is an example of the terminal device according to the present disclosure.

The meeting room includes, for example, as many user terminals 4 as the number of users participating in the meeting. In the example illustrated in FIG. 1, the meeting room R1 includes a user terminal 4A of a user A and a user terminal 4B of a user B. The user A is an example of a first participant according to the present disclosure, and the user B is an example of a second participant according to the present disclosure. The user terminal 4A is an example of a first terminal device according to the present disclosure, and the user terminal 4B is an example of a second terminal device according to the present disclosure.

### Voice Processing Device 1

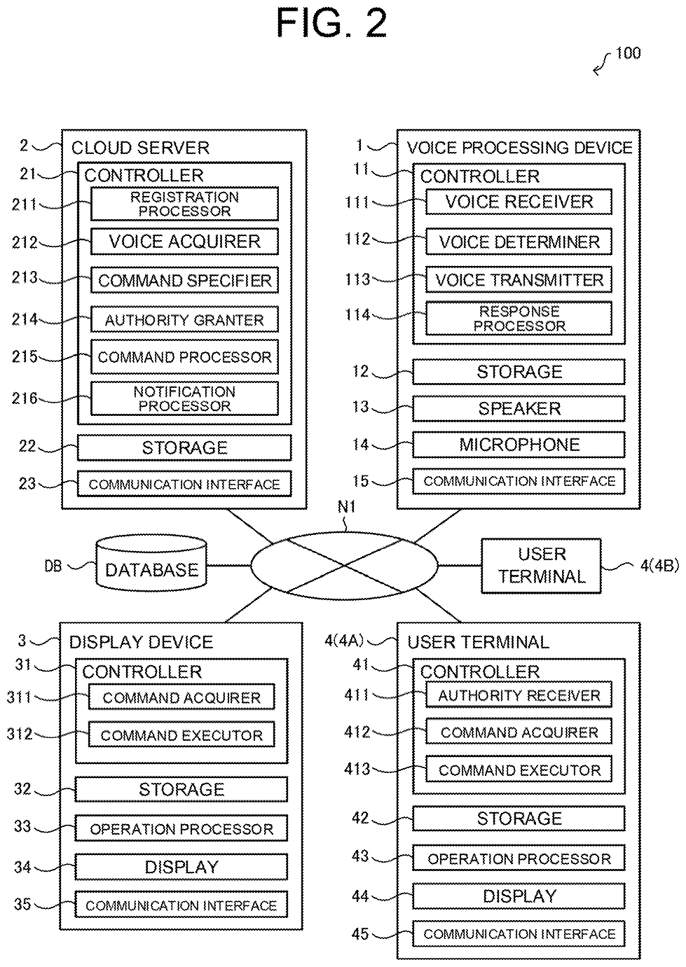

As illustrated in FIG. 2, the voice processing device 1 includes a controller 11, a storage 12, a speaker 13, a microphone 14, a communication interface 15, and the like. The voice processing device 1 may be a device such as an AI speaker or a smart speaker. The voice processing device 1 is placed, for example, on a desk in a meeting room, acquires a voice of a user who participates in a meeting via the microphone 14 and outputs (notifies) a voice from the speaker 13 to the user.

The communication interface 15 connects the voice processing device 1 to the network N1 by wire or wirelessly, and is a communication interface for performing data communication following a predetermined communication protocol, with other devices (e.g., the cloud server 2, the display device 3, the user terminal 4, and the database DB) via the network N1.

The storage 12 is a non-volatile storage such as a flash memory that stores various types of information. The storage 12 stores a control program for causing the controller 11 to execute various control processes. For example, the control program is distributed from the cloud server 2 and stored. The control program may be recorded non-temporarily on a computer-readable recording medium such as a CD or a DVD, and may be read by a reading device (not illustrated) such as a CD drive or a DVD drive mounted in the voice processing device 1 and be stored in the storage 12.

The controller 11 includes a control device such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. Then, the controller 11 controls the voice processing device 1 by causing the CPU to execute various types of control programs stored in advance in the ROM or the storage 12.

Specifically, the controller 11 includes various types of processors such as a voice receiver 111, a voice determiner 112, a voice transmitter 113, and a response processor 114. The controller 11 functions as the various types of processors by causing the CPU to execute various types of processes according to the control programs. Some or all of the processors included in the controller 11 may be implemented by an electronic circuit. The control programs may be programs for causing a plurality of processing devices to function as the various types of processors.

The voice receiver 111 receives a voice uttered by a user who uses the voice processing device 1. The user utters, for example, a voice of a specific word (also referred to as an activation word or a wake-up word) for the voice processing device 1 to start receiving a command, a voice of various commands for instructing the voice processing device 1 (command voice), and the like. The voice receiver 111 receives various types of voices uttered by the user.

The voice determiner 112 determines, based on the voice received by the voice receiver 111, whether the voice includes the specific word. For example, the voice determiner 112 performs voice recognition of the voice received by the voice receiver 111 and converts the voice to text data. Then, the voice determiner 112 determines whether the specific word is included at the beginning of the text data.

The voice transmitter 113, based on the determination result by the voice determiner 112, transmits the command voice received by the voice receiver 111 to the cloud server 2. Specifically, if it is determined by the voice determiner 112 that the specific word is included in the voice received by the voice receiver 111, the voice transmitter 113 assigns the identification information (device ID) of the voice processing device 1 and transmits the command voice included in the voice to the cloud server 2. The voice transmitter 113 may assign the identification information (meeting room ID) of the meeting room in which the voice processing device 1 is installed and transmit the command voice to the cloud server 2. If it is determined by the voice determiner 112 that the specific word is not included in the voice received by the voice receiver 111, the voice transmitter 113 does not transmit the command voice to the cloud server 2. As a result, it is possible to avoid transmitting a normal conversation voice that is different from the command voice, to the cloud server 2.

The response processor 114 acquires, from the cloud server 2, a response (command response) corresponding to the command specified by the cloud server 2, and causes the speaker 13 to output the command response. For example, if the command has content related to output of information search, the response processor 114 acquires the result searched in the cloud server 2, and causes the speaker 13 to output the result.

### Cloud Server 2

As illustrated in FIG. 2, the cloud server 2 includes a controller 21, a storage 22, a communication interface 23, and the like. The cloud server 2 will be described as a single virtual server. The cloud server 2 may be replaced with a single physical server.

The communication interface 23 connects the cloud server 2 to the network N1 by wire or wirelessly, and is a communication interface for performing data communication following a predetermined communication protocol, with other devices (e.g., the voice processing device 1, the display device 3, the user terminal 4, and the database DB) via the network N1.

The storage 22 is a non-volatile storage such as a flash memory that stores various types of information. The storage 22 stores a control program such as a command control processing program for causing the controller 21 to execute a command control process described later. For example, the command control processing program may be recorded non-temporarily in a computer-readable recording medium such as a CD or a DVD, read by a reading device (not illustrated) such as a CD drive or a DVD drive provided in the cloud server 2, and stored in the storage 22. Further, the storage 22 stores the command voice or the like received from the voice processing device 1. The identification information (device ID) of the voice processing device 1 or the identification information (meeting room ID) of the meeting room in which the voice processing device 1 is installed is associated with the command voice.

The controller 21 includes control devices such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. The controller 21 controls the cloud server 2 by causing the CPU to execute various types of control programs stored in advance in the ROM or the storage 22.

The controller 21 executes various types of processes with reference to the database DB. The database DB stores data such as meeting room information D1, device information D2, user information D3, meeting information D4, participating terminal information D5, and participant information D6.

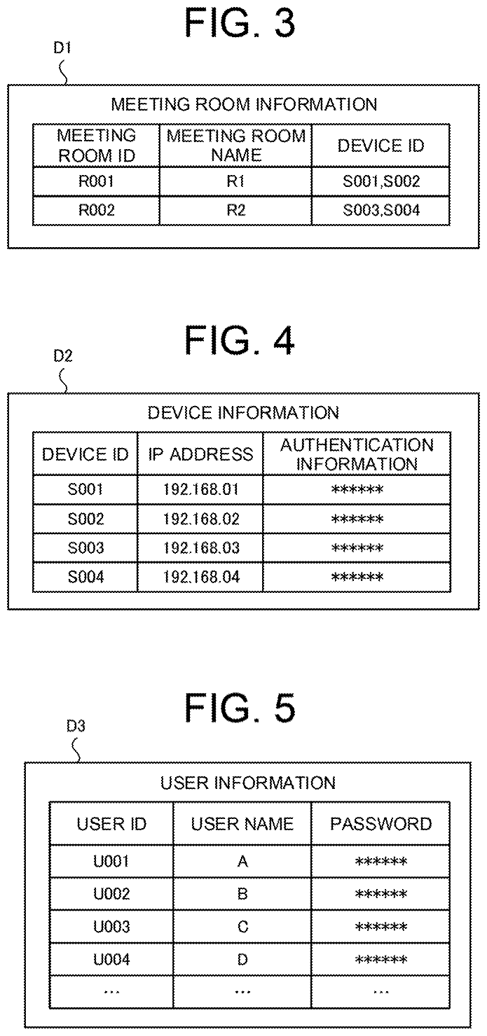

FIG. 3 illustrates an example of the meeting room information D1. In the meeting room information D1, information such as a “meeting room ID”, a “meeting room name”, and a “device ID” corresponding to each meeting room is registered in a mutually associated manner. The “meeting room ID” is identification information of the meeting room, and the “meeting room name” is the name of the meeting room. The “device ID” is identification information of the device installed in the meeting room. For example, if the voice processing device 1 and the display device 3 are installed in the meeting room R1, the identification information “S001” of the voice processing device 1 and the identification information “S002” of the display device 3 are registered in the device ID corresponding to the meeting room R1. Similarly, if the voice processing device 1 and the display device 3 are installed in the meeting room R2, the identification information “S003” of the voice processing device 1 and the identification information “S004” of the display device 3 are registered in the device ID corresponding to the meeting room R2.

FIG. 4 illustrates an example of the device information D2. In the device information D2, information such as a “device ID”, an “IP address”, and “authentication information” corresponding to each device is registered in a mutually associated manner. The “device ID” is identification information of the device installed in the meeting room, and is the same as the “device ID” of the meeting room information D1. The “authentication information” is information for authenticating the device.

FIG. 5 illustrates an example of the user information D3. In the user information D3, information such as a “user ID”, a “user name”, and a “password” corresponding to each user is registered in a mutually associated manner. In the user information D3, information about not only the users participating in the meeting but all users who have the authority to utilize the meeting system 100 is registered in advance. For example, the information of all employees of a company is registered in the user information D3. The “user ID” is identification information of the user, and the “user name” is the name of the user. The “password” is information utilized for login when the user participates in the meeting. For example, a user participating in a meeting launches a meeting application on his/her own user terminal 4 upon starting the meeting, and inputs the user ID and the password being the login information on a login screen. The cloud server 2 performs a login process, based on the login information. A user who has logged in to the meeting application can participate in a meeting utilizing the meeting application.

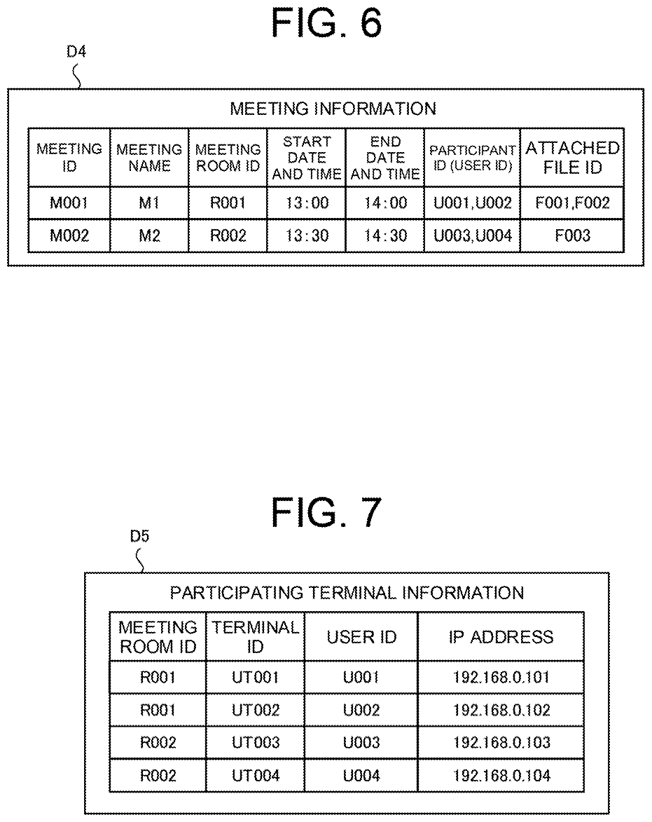

FIG. 6 illustrates an example of the meeting information D4. In the meeting information D4, information such as a “meeting ID”, a “meeting name”, a “meeting room ID”, a “start date and time”, an “end date and time”, a “participant ID”, and an “attached file ID” corresponding to each meeting is registered in a mutually associated manner. The “meeting ID” is identification information of the meeting, and the “meeting name” is the name (subject name) of the meeting. The “start date and time” is the date and time of start of the meeting, and the “end date and time” is the date and time of end of the meeting. The “participant ID” is identification information (user ID) of a user participating in the meeting. The “attached file ID” is identification information of a file (material) used in the meeting, and the file data corresponding to the attached file ID is stored in the database DB. The meeting information D4 is registered in advance by a person in charge or the like, when the schedule of the meeting is decided. FIG. 6 illustrates that the user A (“U001”) and the user B (“U002”) are registered as participants of a meeting M1 held in the meeting room R1 (“R001”), and the user C (“U003”) and the user D (“U004”) are registered as participants of a meeting M2 held in the meeting room R2 (“R002”).

FIG. 7 illustrates an example of the participating terminal information D5. In the participating terminal information D5, information about the user terminal 4 of the user who has logged in upon the start of the meeting is registered. In the participating terminal information D5, information such as the “meeting room ID”, the “terminal ID”, the “user ID”, and the “IP address”, is registered in a mutually associated manner. The “terminal ID” is identification information of the user terminal 4, and the “user ID” is identification information of a user who owns the user terminal 4. Once the user inputs the login information, the identification information of the user terminal 4 of the user is registered in the “terminal ID”. In the participating terminal information D5, information about the user terminal 4 of the users participating in the meeting is registered and updated in real time.

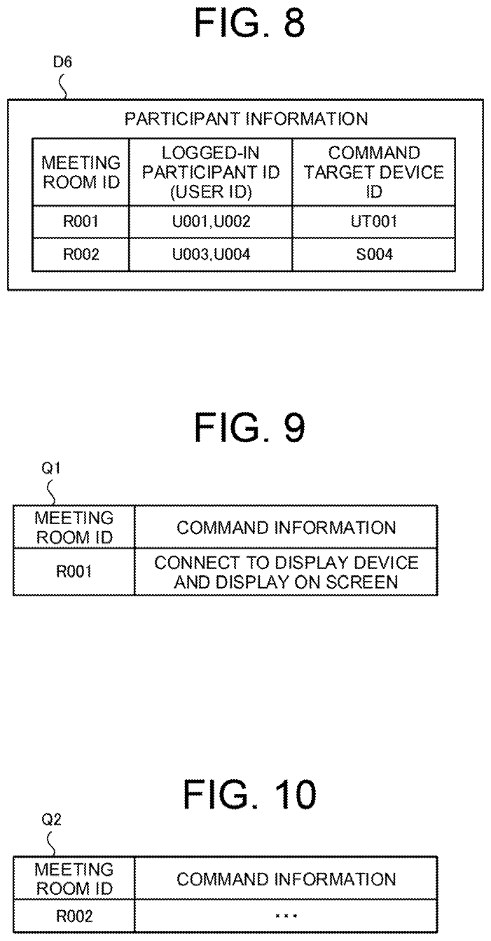

FIG. 8 illustrates an example of the participant information D6. In the participant information D6, information such as a “logged-in participant ID”, and a “command target device ID” corresponding to each meeting room is registered in a mutually associated manner. The “logged-in participant ID” is identification information of a user who has logged in upon the start of the meeting. Once the user inputs the login information, the identification information of the user is registered in the “logged-in participant ID”.

The “command target device ID” is identification information of a device to which the authority to execute the command received by the voice processing device 1 (hereinafter, called the “command execution authority”) is granted. The command execution authority is granted to any device of the voice processing device 1 and the display device 3 installed in the meeting room, or the user terminal 4 owned by the user participating in the meeting in the meeting room, based on operation of the user. The device to which the command execution authority is granted is switched based on operation of the user during the meeting. Therefore, in the “command target device ID”, the identification information of the device to which the command execution authority is currently granted is registered. In the example illustrated in FIG. 8, in the meeting room R1 having the meeting room ID “R001”, the command execution authority is granted to the user terminal 4A (“UT001”) of the user A, and in the meeting room R2 having the meeting room ID “R002”, the command execution authority is granted to the display device 3 (“S004”). Each information registered in the participant information D6 is dynamically updated from the start to the end of the meeting.

A part or all of the information such as the meeting room information D1, the device information D2, the user information D3, the meeting information D4, the participating terminal information D5, and the participant information D6 may be stored in any one of the voice processing device 1, the cloud server 2, the display device 3, and the user terminal 4, or may be dispersedly stored in a plurality of the devices. Each information may be stored in a server accessible from the meeting system 100. In this case, the meeting system 100 may acquire each information from the server and execute each process such as the command control process or the like described later.

As illustrated in FIG. 2, the controller 21 includes various processors such as a registration processor 211, a voice acquirer 212, a command specifier 213, an authority granter 214, a command processor 215, and a notification processor 216. The controller 21 functions as the various types of processors by causing the CPU to execute various types of processes according to the control programs. Some or all of the processors included in the controller 21 may be implemented by an electronic circuit. The control programs may be programs for causing a plurality of processing devices to function as the various types of processors.

The registration processor 211 registers, in the database DB, the location information (meeting room ID) indicating a location (meeting room) where the meeting is held, the identification information (device ID) of the voice processing device 1 installed in the meeting room, and the identification information (device ID) of the user terminal 4 of the user participating in the meeting, in a mutually associated manner. The registration processor 211 is an example of a registration processor according to the present disclosure. Specifically, the registration processor 211 registers, in the meeting room information D1 (see FIG. 3), the meeting room ID, and the identification information (device ID) of the voice processing device 1 and the display device 3 installed in the meeting room in a mutually associated manner, for each meeting room. For example, if the voice processing device 1 and the display device 3 are connected to the network N1 and acquire the IP address and the authentication information (see FIG. 4), the registration processor 211 registers, in the meeting room information D1, the meeting room ID and the device ID.

Further, the registration processor 211 registers, in the participating terminal information D5 (see FIG. 7), the meeting room ID, the user ID of the user who has logged in upon the start of the meeting, and the identification information (terminal ID) of the user terminal 4 owned by the user, in a mutually associated manner. Further, the registration processor 211 registers, in the participant information D6 (see FIG. 8), the meeting room ID and the user ID of the user who has logged in upon the start of the meeting, in a mutually associated manner, for each meeting room. As a result, the meeting room ID of the meeting room where the meeting is held, the device ID of the voice processing device 1 and the device ID of the display device 3 installed in the meeting room, and the terminal ID (device ID) of the user terminal 4 of the user participating in the meeting are registered in a mutually associated manner.

The registration processor 211 may acquire the identification information of the user terminal 4 by utilizing the communication function loaded in the user terminal 4, and may register the identification information in association with the meeting room ID. For example, the registration processor 211 may acquire the identification information of the user terminal 4 by utilizing a beacon, a short-range wireless communication device, or the like installed in the meeting room, and may register the identification information in association with the meeting room ID.

The voice acquirer 212 acquires voice information via the voice processing device 1 in the meeting. The voice acquirer 212 is an example of a voice acquirer according to the present disclosure. Specifically, the voice acquirer 212 acquires the command voice transmitted from the voice processing device 1. The command voice is a word (text data) following a specific word included at the beginning of text data of voice received by the voice processing device 1. Specifically, if the voice processing device 1 detects the specific word and transmits the command voice to the cloud server 2, the voice acquirer 212 of the cloud server 2 acquires the command voice. The identification information (device ID) of the voice processing device 1 or the identification information (meeting room ID) of the meeting room in which the voice processing device 1 is installed is associated with the command voice.

The command specifier 213 specifies a command, based on the command voice received by the voice acquirer 212. The command specifier 213 is an example of the command specifier 213 according to the present disclosure. For example, a combination of text data corresponding to a plurality of the command voices and the command may be registered in the database DB in advance. In this case, the command specifier 213 specifies the command corresponding to the command voice with reference to the database DB. However, the command specification method is not limited thereto. For example, the command specifier 213 may specify the command by interpreting the meaning of the instructions of the user, based on a predetermined term included in the text data of the command voice, a clause, a syntax, or the like of the entire text data. For example, the command specifier 213 may specify the command from the command voice using a known method such as morphological analysis, syntactic analysis, semantic analysis, machine learning, or the like.

The authority granter 214 grants the command execution authority to a predetermined device among the devices associated with the meeting room. The authority granter 214 is an example of the authority granter according to the present disclosure. For example, in the meeting room R1, the authority granter 214 grants the command execution authority to the voice processing device 1 (“S001”) or the display device 3 (“S002”), based on the command voice. For example, in the meeting room R1, the authority granter 214 grants the command execution authority to the user terminal 4A (“UT001”), based on the operation of the user A (a grant request for the command execution authority (described later)), or grants the command execution authority to the user terminal 4B (“UT002”), based on the operation of the user B (a grant request for the command execution authority). If the authority granter 214 grants the command execution authority to any device, the registration processor 211 registers the identification information (device ID) of the device to which the command execution authority is granted, in the “command target device ID” of the participant information D6 (see FIG. 8).

The command processor 215 stores the information of the command specified by the command specifier 213, in a command storage area (a queue) corresponding to the meeting room associated with the device to which the command execution authority is granted by the authority granter 214. For example, the storage 22 includes one or more queues corresponding to the meeting room ID registered in the meeting information D4 (see FIG. 6). The queue is provided for each meeting room. Here, the storage 22 includes a first queue Q1 (see FIG. 9) corresponding to the meeting room R1 having the meeting room ID “R001”, and a second queue Q2 (see FIG. 10) corresponding to the meeting room R2 having the meeting room ID “R002”.

For example, as illustrated in FIG. 9, the command processor 215 stores the information of the command specified by the command specifier 213 (“connect to the display device and display on screen”), in the first queue Q1 corresponding to the meeting room ID “R001” specified based on the command voice. For example, the command processor 215 acquires the device ID “S001” of the voice processing device 1 assigned to the command voice, specifies the meeting room ID “R001” associated with the device ID “S001” with reference to the meeting room information D1 (see FIG. 3), and stores the information of the command, in the first queue Q1 corresponding to the specified meeting room ID “R001”.

The data (command) stored in each queue is extracted by the command target device associated with the meeting room corresponding to each queue, and the command target device executes the command.

The notification processor 216 notifies each user terminal 4 registered in the participating terminal information D5 (see FIG. 7) of the information indicating a device to which the command execution authority is currently granted. The notification processor 216 is an example of a notification processor according to the present disclosure. For example, if the command execution authority is granted to the user terminal 4A in the meeting room R1 having the meeting room ID “R001”, the notification processor 216 notifies the user terminals 4A and 4B associated with the meeting room R1 of the information related to the user terminal 4A (the terminal ID “UT001”) (see FIG. 8) to which the command execution authority is granted.

### Display Device 3

As illustrated in FIG. 2, the display device 3 includes a controller 31, a storage 32, an operation processor 33, a display 34, a communication interface 35, and the like.

The operation processor 33 is a mouse, a keyboard, a touch panel, or the like that receives an operation of a user of the display device 3. The display 34 is a display panel such as a liquid crystal display or an organic EL display that displays various types of information. The operation processor 33 and the display 34 may be an integrally formed user interface.

The communication interface 35 connects the display device 3 to the network N1 by wire or wirelessly, and is a communication interface for performing data communication following a predetermined communication protocol, with other devices (e.g., the voice processing device 1, the cloud server 2, the user terminal 4, and the database DB) via the network N1.

The storage 32 is a non-volatile storage such as a flash memory that stores various types of information. The storage 32 stores a control program for causing the controller 31 to execute various control processes. For example, the control program may also be recorded non-temporarily on a computer-readable recording medium such as a CD or a DVD, and may be read by a reading device (not illustrated) such as a CD drive or a DVD drive mounted in the display device 3 and be stored in the storage 32.

The controller 31 includes control devices such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. The controller 31 controls the display device 3 by causing the CPU to execute various types of control programs stored in advance in the ROM or the storage 32.

Specifically, the controller 31 includes various types of processors such as a command acquirer 311 and a command executor 312. The controller 31 functions as the various types of processors by causing the CPU to execute various types of processes according to the control programs. Some or all of the processors included in the controller 31 may be implemented by an electronic circuit. The control programs may be programs for causing a plurality of processing devices to function as the various types of processors.

The command acquirer 311 acquires a command stored in the command storage area (a queue) of the cloud server 2. Specifically, for example, if the authority granter 214 grants the command execution authority to the display device 3 installed in the meeting room R1, the command acquirer 311 of the display device 3 acquires a command from the first queue Q1 corresponding to the meeting room R1. Similarly, if the authority granter 214 grants the command execution authority to the display device 3 installed in the meeting room R2, the command acquirer 311 of the display device 3 acquires a command from the second queue Q2 corresponding to the meeting room R2. The command processor 215 of the cloud server 2 may transmit the data related to the command to the corresponding display device 3, and the command acquirer 311 may acquire the command.

The command executor 312 executes the command acquired by the command acquirer 311. For example, the command executor 312 of the display device 3 in the meeting room R1 executes the command stored in the first queue Q1 acquired by the command acquirer 311. Similarly, the command executor 312 of the display device 3 in the meeting room R2 executes the command stored in the second queue Q2 acquired by the command acquirer 311.

For example, if the user A utters a voice corresponding to a command for displaying a predetermined material on the display device 3 to the voice processing device 1, in the meeting room R1, the command executor 312 of the display device 3 to which the command execution authority is granted based on the command voice displays the material on the display 34.

### User Terminal 4

As illustrated in FIG. 2, the user terminal 4 includes a controller 41, a storage 42, an operation processor 43, a display 44, a communication interface 45, and the like.

The operation processor 43 is a mouse, a keyboard, a touch panel, or the like that receives an operation of a user of the user terminal 4. The display 44 is a display panel such as a liquid crystal display or an organic EL display that displays various types of information. The operation processor 43 and the display 44 may be an integrally formed user interface.

The communication interface 45 connects the user terminal 4 to the network N1 by wire or wirelessly, and is a communication interface for performing data communication following a predetermined communication protocol, with other devices (e.g., the voice processing device 1, the cloud server 2, the display device 3, and the database DB) via the network N1.

The storage 42 is a non-volatile storage such as a flash memory that stores various types of information. The storage 42 stores a control program such as a command control processing program for causing the controller 41 to execute a command control process described later. For example, the command control processing program may be recorded non-temporarily in a computer-readable recording medium such as a CD or a DVD, read by a reading device (not illustrated) such as a CD drive or a DVD drive provided in the user terminal 4, and stored in the storage 42.

The controller 41 includes control devices such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. The controller 41 controls the user terminal 4 by causing the CPU to execute various types of control programs stored in advance in the ROM or the storage 42.

Specifically, the controller 41 includes various types of processors such as an authority receiver 411, a command acquirer 412, and a command executor 413. The controller 41 functions as the various types of processors by causing the CPU to execute various types of processes according to the control programs. Some or all of the processors included in the controller 41 may be implemented by an electronic circuit. The control programs may be programs for causing a plurality of processing devices to function as the various types of processors.

The authority receiver 411 receives a grant request for the command execution authority. The authority receiver 411 is an example of an authority receiver according to the present disclosure. Specifically, the authority receiver 411 receives an operation from a user (participant) requesting the grant of the command execution authority to his/her own user terminal 4 during the meeting. For example, if the meeting M1 is started in the meeting room R1 and the user A is authenticated, the operation screen of the meeting application illustrated in FIG. 11 is displayed on the user terminal 4A of the user A. The operation screen displays a selection screen for an attached file registered in the meeting information D4 (see FIG. 6), a request button K1 for requesting the command execution authority, an end button K2 for ending the meeting (meeting application), and information about a device to which the command execution authority is currently granted or information about the user of the device. Here, if the user A presses (selects) the request button K1 for requesting the command execution authority on the operation screen (see FIG. 11) displayed on the user terminal 4A, the authority receiver 411 receives the grant request. In this way, an operation screen for selecting the grant request from the user is displayed on each user terminal 4 of each authenticated user.

Upon receiving the grant request, the authority receiver 411 transmits the grant request to the cloud server 2. Upon acquiring the grant request, the authority granter 214 of the cloud server 2 grants the command execution authority to the device requesting the grant, based on the meeting room information D1, the meeting information D4, the participating terminal information D5, the participant information D6, and the like. For example, in a case where, in the meeting room R1, the authority receiver 411 of the user terminal 4A receives the grant request from the user A and transmits the grant request to the cloud server 2, the authority granter 214 grants the command execution authority to the user terminal 4A if grant conditions such as the fact that the user A of the user terminal 4A is already logged in (see FIG. 8), the user A is a meeting participant (see FIG. 6), the user terminal 4A is a terminal owned by the user A (see FIG. 7), and the like are satisfied. Further, for example, in a case where, in the meeting room R1, the authority receiver 411 of the user terminal 4B receives the grant request from the user B and transmits the grant request to the cloud server 2, the authority granter 214 grants the command execution authority to the user terminal 4B if grant conditions such as the fact that the user B of the user terminal 4B is already logged in (see FIG. 8), the user B is a meeting participant (see FIG. 6), the user terminal 4B is a terminal owned by the user B (see FIG. 7), and the like are satisfied.

In a case where the authority granter 214 acquires the grant request from the user terminal 4B in a state where the command execution authority is granted to the user terminal 4A, the authority granter 214 switches the grant target of the command execution authority from the user terminal 4A to the user terminal 4B if the grant conditions are satisfied. Further, in this case, if the user B presses the request button K1 on the user terminal 4B, the authority granter 214 may return the grant target of the command execution authority to the user terminal 4A.

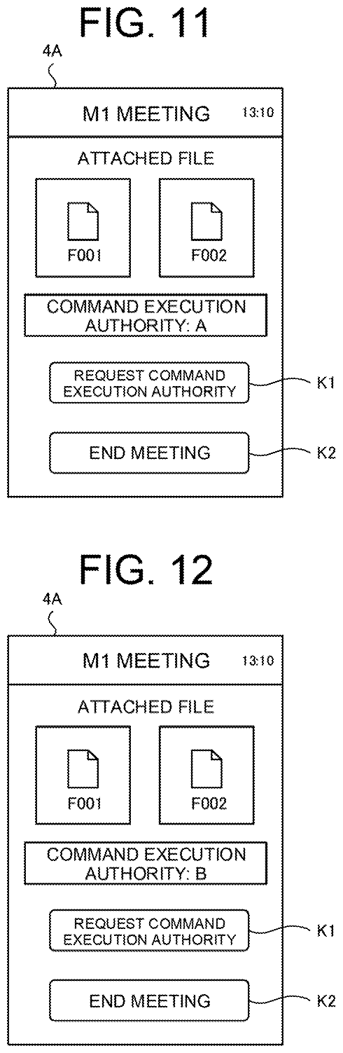

Here, the controller 41 of each user terminal 4 acquires, from the cloud server 2 (the notification processor 216), information indicating the device to which the command execution authority is currently granted. Upon acquiring the information, the controller 41 displays the information on the operation screen. In FIG. 11, information indicating that the command execution authority is granted to the user terminal 4A of the user A is displayed. In FIG. 12, information indicating that the command execution authority is granted to the user terminal 4B of the user B is displayed.

The method of request for the grant of the command execution authority by the user is not limited to the method of pressing the request button K1 on the operation screen (see FIG. 11). For example, the user may perform an operation for the grant request upon launching the meeting application. Alternatively, the user may make the grant request by voice. For example, the user A utters the identification information of the user terminal 4A in speech, and the voice requesting for the grant of the command execution authority, to the voice processing device 1. The authority granter 214 grants the command execution authority based on the voice information acquired from the voice processing device 1. Further, the authority granter 214 may switch the command execution authority from the user terminal 4A to the user terminal 4B, when the user A utters an instruction requesting for switching of the command execution authority to the user B. Further, the authority granter 214 may initially grant the command execution authority to the user terminal 4 that is the first to launch the meeting application.

The command acquirer 412 acquires a command stored in the command storage area (a queue) of the cloud server 2. Specifically, for example, if the authority granter 214 grants the command execution authority to the user terminal 4A installed in the meeting room R1, the command acquirer 412 of the user terminal 4A acquires a command from the first queue Q1 corresponding to the meeting room R1. Similarly, if the authority granter 214 grants the command execution authority to the user terminal 4B installed in the meeting room R1, the command acquirer 412 of the user terminal 4B acquires a command from the first queue Q1 corresponding to the meeting room R1. The command processor 215 of the cloud server 2 may transmit, to the corresponding user terminal 4, the data related to the command, and the command acquirer 412 may acquire the command.

The command executor 413 executes the command acquired by the command acquirer 412. For example, the command executor 413 of the user terminal 4A in the meeting room R1 executes the command stored in the first queue Q1 acquired by the command acquirer 412. Similarly, the command executor 413 of the user terminal 4B in the meeting room R1 executes the command stored in the first queue Q1 acquired by the command acquirer 412.

For example, in the meeting room R1, if the user A of the user terminal 4A to which the command execution authority is granted utters the command voice “connect to the display device and display on screen” to the voice processing device 1, the command executor 413 of the user terminal 4A connects the user terminal 4A to the display device 3, and causes the display device 3 to display the display screen (an example of the display information of the present disclosure) displayed on the display 44 of the user terminal 4A.

Further, for example, in the meeting room R1, if the user B of the user terminal 4B to which the command execution authority is granted utters the command voice “search for the material and display on screen” to the voice processing device 1, the command executor 413 of the user terminal 4B extracts the material (for example, the attached file) and displays the extracted material on the display 44 of the user terminal 4B.

The voice processing device 1 may start receiving the command voice from the user from the time the command execution authority is granted to the user terminal 4. If the command executor 413 executes a predetermined command, the response processor 114 of the voice processing device 1 may cause the speaker 13 to output a voice according to the execution of the command. For example, if the command is executed according to the voice of the user A, the response processor 114 outputs the voice “displayed on the display device”. For example, if the command is executed according to the voice of the user B, the response processor 114 outputs the voice “displayed the material on the user terminal 4B”.

As described above, each of the plurality of users participating in the meeting executes the desired command while switching the command execution authority using his/her own user terminal 4 during the meeting.

### Command Control Process

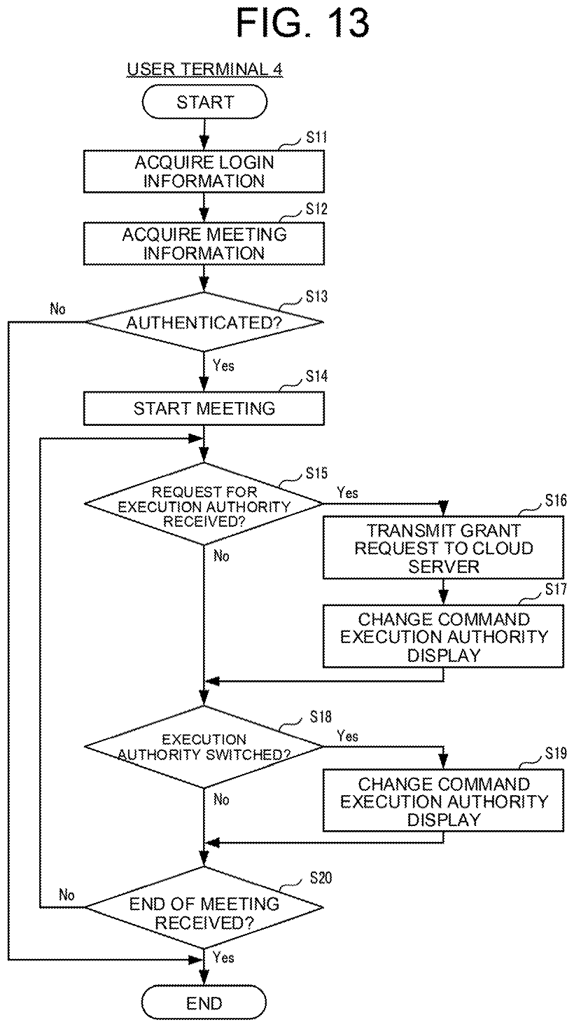

Next, an example of the procedure of the command control process executed in the meeting system 100 will be described with reference to FIGS. 13 to 16.

The present disclosure can be regarded as an invention of a command control processing method (an example of the information processing method of the present disclosure) in which one or more steps included in the command control process are executed. One or more steps included in the command control process described here may be omitted where appropriate. Each of the steps in the command control process may be executed in a different order as long as a similar operation and effect are achieved. Although a case where each of the steps in the command control process is executed by each controller of the devices (the voice processing device 1, the cloud server 2, the display device 3, and the user terminal 4) included in the meeting system 100 will be described as an example here, in another embodiment, each of the steps in the command control process may be dispersedly executed by one or more processing devices.

Here, the command control process corresponding to the meeting M1 held in the meeting room R1 described above will be described as an example. FIG. 13 is a flowchart illustrating an example of a procedure of the request process of the command execution authority included in the command control process executed in the user terminal 4A. For example, the controller 41 of the user terminal 4A starts the execution of the command control processing program by launching the meeting application, thereby starting the execution of the request process. The request process is individually and concurrently executed in each of the user terminals 4A and 4B corresponding to the meeting room R1, for example.

In step S11, the meeting application is launched, and then the controller 41 of the user terminal 4A receives a login operation from the user A. For example, the controller 41 acquires login information (the user ID and password) input by the user A on the login screen.

Next, in step S12, the controller 41 acquires the meeting information from the cloud server 2. Specifically, the controller 41 acquires, from the cloud server 2, each information included in the meeting information D4 (see FIG. 6) of the meeting in which the user A specified by the login information of the user A participates.

Next, in step S13, the controller 41 executes an authentication process for authenticating the user A, based on the login information and the meeting information. For example, the controller 41 determines whether authentication conditions are satisfied, for example, whether the current time is included in the time of holding the meeting M1 (the start date and time to the end date and time) registered in the meeting information, whether the meeting room R1 is registered in the meeting information, and whether the user A is registered in the meeting information as a participant of the meeting M1. If the authentication conditions are satisfied (S13: Yes), the processing proceeds to step S14, and if the authentication conditions are not satisfied (S13: No), the processing ends.

If the authentication conditions are satisfied, the controller 41 authenticates the user A and starts the meeting in step S14. For example, the controller 41 causes the user terminal 4A to display the operation screen (see FIG. 11) of the meeting application and permits participation in the meeting.

Next, in step S15, the controller 41 determines whether the grant request for the command execution authority is received. For example, the controller 41 of the user terminal 4A determines whether the request button K1 is pressed by the user A on the operation screen illustrated in FIG. 11. If the request button K1 is pressed by the user A, the controller 41 determines that the grant request for the command execution authority is received from the user A. Step S15 is an example of an authority reception process according to the present disclosure.

If a grant request for the command execution authority is received from the user A (S15: Yes), the controller 41 transmits the grant request to the cloud server 2 in step S16.

Upon acquiring the grant request, the controller 21 of the cloud server 2 grants the command execution authority to the device requesting the grant (the user terminal 4A), based on the meeting room information D1, the meeting information D4, the participating terminal information D5, the participant information D6, and the like.

If the command execution authority is granted by the cloud server 2 to the user terminal 4A, then in step S17, the controller 41 of each user terminal 4 displays, on the operation screen, information indicating that the command execution authority is granted to the user terminal 4A (see FIG. 11). This allows the user A to recognize that the current command execution authority lies with the user A him/herself, and allows the user B to recognize that the current command execution authority lies with the user A.

In step S18, the controller 41 determines whether the command execution authority has been switched. For example, in a case where the user B makes a grant request for the command execution authority in a state where the command execution authority has been granted to the user terminal 4A, the grant target of the command execution authority is switched from the user terminal 4A to the user terminal 4B if the grant conditions corresponding to the user terminal 4B are satisfied. If the command execution authority is switched (S18: Yes), the processing proceeds to step S19.

In step S19, the controller 41 of each user terminal 4 displays, on the operation screen, information indicating that the command execution authority has been switched to the user terminal 4B (see FIG. 12). This allows the user A to recognize that the current command execution authority lies with the user B, and allows the user B to recognize that the current command execution authority lies with the user B him/herself.

In step S20, the controller 41 determines whether an end of meeting is received. For example, if the end button K2 is pressed by the user A on the operation screen (FIGS. 11 and 12), the controller 41 determines that an end of meeting is received from the user A. As a result, for example, the meeting application is ended on the user terminal 4A, and the user A exits the meeting room R1. If the user A presses the end button K2 in a state where the command execution authority has been granted to the user terminal 4A, the controller 41 cancels the command execution authority of the user terminal 4A.

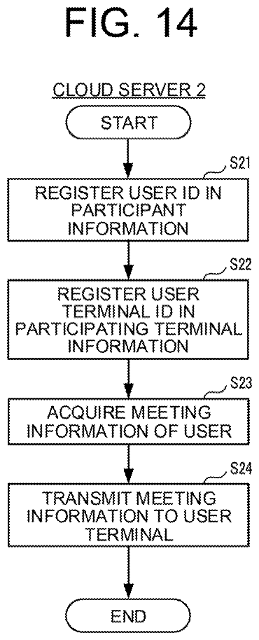

FIG. 14 is a flowchart illustrating an example of a procedure of a registration processing included in the command control process executed in the cloud server 2. For example, the controller 21 of the cloud server 2 starts the execution of the registration processing if the login information is input on the user terminal 4.

In step S21, the controller 21 registers the user ID acquired from the user terminal 4 in the participant information D6 (see FIG. 8). Here, the user IDs “U001” and “U002” corresponding to the logged-in users A and B, and the meeting room ID “R001” are registered in the participant information D6 in a mutually associated manner.

Next, in step S22, the controller 21 registers the identification information of the user terminal 4 (the user terminal ID) in the participating terminal information D5 (see FIG. 7). Here, the user terminal IDs “UT001” and “UT002” corresponding to the logged-in users A and B, and the meeting room ID “R001” are registered in the participating terminal information D5 in a mutually associated manner. Steps S21 and S22 are examples of a registration process according to the present disclosure.

Next, in step S23, the controller 21 acquires the meeting information corresponding to the logged-in user. For example, the controller 21 acquires the meeting information corresponding to the user A from the meeting information D4 of the database DB.

Next, in step S24, the controller 21 transmits the meeting information to the user terminal 4. For example, the controller 41 transmits each information included in the meeting information D4 (see FIG. 6) to the user terminal 4A of the user A. Each information is used in the authentication process (the processing in step S13 of FIG. 13) in the user terminal 4A. The registration processing is executed each time a login operation is performed on each user terminal 4.

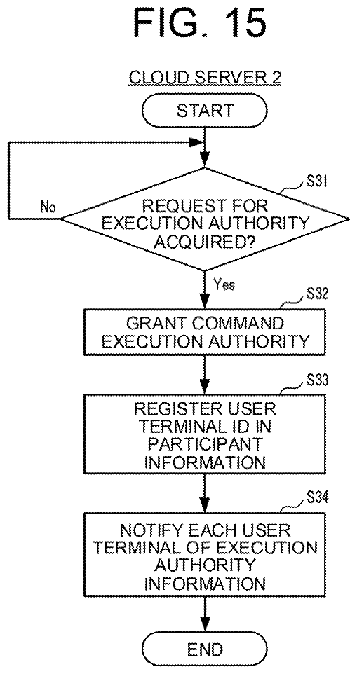

FIG. 15 is a flowchart illustrating an example of a procedure of the grant process for the command execution authority included in the command control process executed in the cloud server 2. For example, the controller 21 of the cloud server 2 starts the execution of the grant process upon acquiring the grant request for the command execution authority from the user terminal 4.

In step S31, the controller 21 waits until the grant request is acquired, and if the grant request is acquired, the processing proceeds to step S32.

In step S32, the controller 21 grants the command execution authority to the device requesting the grant (for example, the user terminal 4A), based on the meeting room information D1, the meeting information D4, the participating terminal information D5, the participant information D6, and the like. Step S32 is an example of an authority grant process according to the present disclosure.

In step S33, the controller 21 registers, in the participant information D6, the information about the device to which the command execution authority is granted. For example, if the command execution authority is granted to the user terminal 4A, the controller 21 registers the user terminal ID “UT001” of the user terminal 4A, in the “command target device ID” of the participant information D6 (see FIG. 8). If the grant request is acquired from the user terminal 4B and the command execution authority is granted to the user terminal 4B, the controller 21 registers the user terminal ID “UT002” of the user terminal 4B, in the “command target device ID” of the participant information D6.

Next, in step S34, the controller 21 notifies each user terminal 4 registered in the participating terminal information D5 (see FIG. 7) of the information indicating a device to which the command execution authority is currently granted. For example, if the command execution authority is granted to the user terminal 4A in the meeting room R1 having the meeting room ID “R001”, the controller 21 notifies the user terminals 4A and 4B associated with the meeting room R1 of the information related to the user terminal 4A (the terminal ID “UT001”) (see FIG. 8) to which the command execution authority is granted. The grant process is executed each time the grant request is acquired.

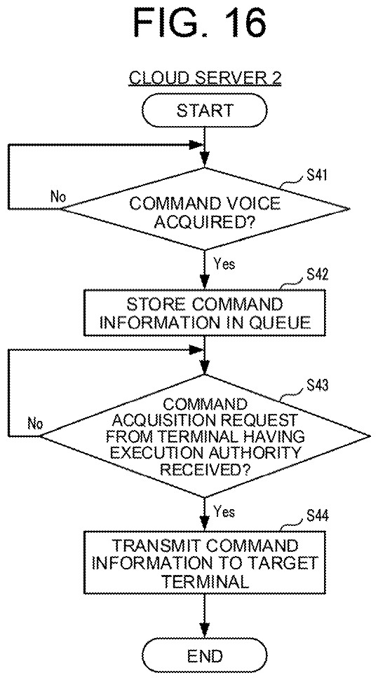

FIG. 16 is a flowchart illustrating an example of a procedure of a command process included in the command control process executed in the cloud server 2. For example, the controller 21 of the cloud server 2 starts the execution of the command process upon acquiring a command voice from the voice processing device 1.

In step S41, the controller 21 waits until the command voice is acquired from the voice processing device 1, and if the command voice is acquired, the processing proceeds to step S42. Step S41 is an example of a voice acquisition process according to the present disclosure.

In step S42, the controller 21 stores, in the queue of the storage 22, the information about the command corresponding to the command voice. For example, if the command voice is acquired from the voice processing device 1 of the meeting room R1 after the command execution authority is granted to the user terminal 4A, the controller 21 specifies the command corresponding to the command voice, and stores the information about the command, in the first queue Q1 (see FIG. 9) corresponding to the meeting room R1 specified based on the command voice. Step S42 is an example of a command specification process according to the present disclosure.

Next, in step S43, the controller 21 determines whether an acquisition request for the command is received from a device having the command execution authority. For example, if an acquisition request for the command stored in the first queue Q1 (see FIG. 9) is received from the user terminal 4A having the command execution authority (S43: Yes), the processing proceeds to step S44.

In step S44, the controller 21 transmits the command to the device having the command execution authority. For example, the controller 21 transmits the command stored in the first queue Q1 (see FIG. 9) to the user terminal 4A. The controller 41 of the user terminal 4A acquires the command from the first queue Q1 and executes the command. The command processing is executed each time the command voice is acquired.

As described above, the meeting system 100 executes the command control process. As described above, in the meeting system 100 according to the present embodiment, the identification information of the meeting room and the identification information of each of the voice processing device 1, the display device 3, and the user terminal 4 are registered for each meeting room in a mutually associated manner. In the meeting system 100, the authority to execute the command corresponding to the command voice is granted in response to a request from a user participating in the meeting. Therefore, upon switching the command execution authority among a plurality of user terminals 4 during a meeting, it is not necessary to perform the registration and cancellation processing for the user terminal 4. Therefore, it is possible to efficiently switch the target device in which a command by voice is executed during a meeting.

In the information processing system according to the present disclosure, within the scope of the invention described in claims, the embodiments described above may be freely combined, or the embodiments may be appropriately modified or some of the embodiments may be omitted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system, comprising:
a registration processor that registers, in a storage, location information indicating a location where a meeting is held, identification information of a voice processing device installed at the location where the meeting is held, and identification information of a terminal device of a participant participating in the meeting, in a mutually associated manner;
a voice acquirer that acquires voice information via the voice processing device in the meeting;
a command specifier that specifies a command for executing a predetermined process, based on the voice information acquired from the voice acquirer;
an authority receiver that receives a grant request for an authority to execute the command specified by the command specifier; and
an authority granter that grants the authority to a predetermined terminal device, based on the location information and the identification information of the terminal device stored in the storage, if the grant request is received by the authority receiver.

2. The information processing system according to claim 1, wherein the authority receiver receives the grant request from a first terminal device of a first participant, and
the authority granter grants the authority to the first terminal device if identification information of the first terminal device is associated with the location information.

3. The information processing system according to claim 2, wherein, in a case where the authority receiver receives the grant request from a second terminal device of a second participant in a state where the authority is granted to the first terminal device, the authority granter switches the grant target of the authority from the first terminal device to the second terminal device if identification information of the second terminal device is associated with the location information.

4. The information processing system according to claim 1, wherein the authority receiver receives the grant request, based on an operation input by the participant on an operation screen displayed on the terminal device of the participant.

5. The information processing system according to claim 1, wherein the registration processor registers, in the storage, the identification information of the terminal device, based on login information input by the participant to the terminal device at the location where the meeting is held.

6. The information processing system according to claim 1, further comprising a notification processor that notifies each of the terminal devices registered in the storage of information indicating the terminal device to which the authority is currently granted.

7. The information processing system according to claim 1, further comprising:
the terminal device; and
a display device that is installed at the location where the meeting is held and that performs data communication with the terminal device, wherein
the terminal device to which the authority is granted causes the display device to display predetermined display information, based on the command.

8. The information processing system according to claim 7, wherein a plurality of the terminal devices associated with the location information each display an operation screen for selecting the grant request from the participant.

9. The information processing system according to claim 8, wherein the plurality of terminal devices associated with the location information each display, on the operation screen, information indicating the terminal device to which the authority is currently granted.

10. An information processing method comprising using one or more processing devices to execute:
registering, in a storage, location information indicating a location where a meeting is held, identification information of a voice processing device installed at the location where the meeting is held, and identification information of a terminal device of a participant participating in the meeting, in a mutually associated manner;
acquiring voice information via the voice processing device in the meeting;
specifying a command for executing a predetermined process based on the voice information acquired;
receiving a grant request for an authority to execute the command specified; and
granting the authority to a predetermined terminal device, based on the location information and the identification information of the terminal device stored in the storage, if the grant request is received.

11. A non-transitory storage medium for storing an information processing program for causing one or more processing devices to execute:
registering, in a storage, location information indicating a location where a meeting is held, identification information of a voice processing device installed at the location where the meeting is held, and identification information of a terminal device of a participant participating in the meeting, in a mutually associated manner;
acquiring voice information via the voice processing device in the meeting;
specifying a command for executing a predetermined process based on the voice information acquired;
receiving a grant request for an authority to execute the command specified; and
granting the authority to a predetermined terminal device, based on the location information and the identification information of the terminal device stored in the storage, if the grant request is received.
